(19) United States
(12) Patent Application Publication
(10) Pub. No.: US 2007/0189293 A1
(43) Pub. Date: Aug. 16, 2007

(54) QoS guarantee system in multidomain network and QoS server applied to the same

(75) Inventors: Akiko Yamada, Kawasaki (JP); Koji Nakamichi, Kawasaki (JP); Hitoshi Yamada, Tokyo (JP)

Correspondence Address: BINGHAM MCCUTCHEN LLP, 2020 K Street, N.W., Intellectual Property Department, WASHINGTON, DC, 20006, US

(73) Assignee: FUJITSU LIMITED

(21) Appl. No.: 11/472,431

(22) Filed: Jun. 22, 2006

(30) Foreign Application Priority Data
Feb. 15, 2006 (JP) 2006-38274

(51) Int. Cl. H04L 12/56

(52) U.S. Cl. 370/392; 370/401

(57) ABSTRACT

Disclosed is a QoS guaranteeing method on a network path across a plurality of domains, among QoS servers linking the domains included in each of a plurality of domains, the QoS server included in the domain defined as a QoS guaranteeing resource request source performing the steps of generating a QoS guaranteeing resource request message; sending the generated QoS guaranteeing resource request message to the QoS server managing the next domain on the path; and if resources can be reserved in all the domains on the path as a result of the QoS guaranteeing resource request of the QoS guaranteeing resource request message, managing the resources for the obtained QoS guarantee on the path from the next domain to the domain where a destination network address belongs.

### CROSS-REFERENCE TO RELATED APPLICATIONS

This application is based upon and claims the benefit of priority from the prior Japanese Patent Application No. 2006-38274, filed on Feb. 15, 2006, the entire contents of which are incorporated herein by reference.

### BACKGROUND OF THE INVENTION

1. Field of the Invention

The present invention relates to a QoS guaranteeing method in multidomain network and a QoS server applied to the same and relates to a QoS guaranteeing method and a QoS server applied to the same for guaranteeing end-to-end communication quality dynamically and efficiently when a plurality of management domains constitute a network system capable of guaranteeing QoS.

2. Description of the Related Art

To achieve quality guarantee communication, a bandwidth must be reserved for each data flow in an end-to-end manner. In large scale network, a communication path generally passes through a plurality of domains and, in this case, a bandwidth must be reserved in all the management domains on the path of the data flow.

With regard to such needs, the relevant prior arts are as follows.

In a first method, network resources on the path are reserved by RSVP (Resource reservation Protocol) in RFC2205, Version 1 Functional Specification shown in FIG. 1.

In FIG. 1, paths are established on domains A, B to send traffic characteristics and path information sequentially from a transmission source (sender) 100 with path messages and a reception destination (receiver) 101 sends reservation (RESV) massages to the transmission source (sender) 100. The data path is reserved by performing necessary setup with routers R on the path.

Although this method works if the routers on the path do not support the RSVP, all the routers R must support the RSVP to certainly perform the QoS guarantee reservation on the path. Since the routers R must maintain the information of each flow, it is problematic that a network scale (scalability) is limited.

A second prior art is also known, which is “System and Method for Providing Quality-Guaranteed Communication Service Corresponding to Multi-Domain, And Service Mediating Device” described in Japan Patent No. 3617406. FIG. 2 shows an explanatory diagram of this technology.

Network service management apparatuses 2A, 2B are provided correspondingly to domains A, B, and a multidomain service broker 1 is provided at a higher level for managing the network service management apparatuses 2A, 2B.

When requested by a customer 100a of transmission source network 100 (step S1), the network service management apparatus 2A of the corresponding domain A queries the multidomain service broker 1 for a path and information of other network service management apparatuses with which negotiation should be performed (step S2).

The multidomain service broker 1 notifies the network service management apparatus 2B of the other domain B (step S3), and the network service management apparatus 2A negotiates with the network service management apparatus 2B (step S4) to perform setup of each domain (step S5) . After the setup, a response is returned to the customer 100a to indicate that the setup is performed (step S6), and the QoS guarantee is achieved on the path in multidomain.

In the method shown in FIG. 2, it is problematic that long processing time is required after the request of the customer 100a to the network service management apparatus 2A (Si) until the response to the customer (S6).

A third prior art is a paper-based contract (SLA agreement, Service Level Agreement). In this method, domain administrators (network providers) make a contract with each other for the transfer with QoS guarantee and perform setup for executing the contract.

That is, referring to FIG. 3 showing the third prior art, an administrator of a network domain A and an administrator of a network domain B make a contract of transferring 30-Mbps traffic with less delay and no packet loss (SS1).

In each domain A, B, the content of the contract is registered, i.e., network devices are set such that the contract can be executed (SS2).

When a customer 100a requests through network (a) 100 to use, for example, 1 Mbps between network band network c (SS3), it is checked whether a QoS server 10, etc. can be used within the contract bandwidth or not by checking and updating the bandwidth that has been permitted to set (SS4). If the bandwidth can be used (in the example of FIG. 3, since 27 Mbps can be used), a response for usage permission is returned (SS5) and the QoS guarantee communication is achieved across multidomain.

However, in such a method, since the bandwidth is continuously reserved even when not used, the bandwidth is wasted. If the requests from the customer 100a are increased and the bandwidth becomes insufficient, the contract and the setting cannot be changed immediately and call losses are generated.

If the contract is changed in accordance with temporary increase in requests, it is problematic that operation is needed for restoring the contract again, which is troublesome.

A fourth prior art is a technology described in Japanese Patent Application Laid-Open Publication No. 2002-74207. In this prior art, policy servers of network domains make the SLA agreement requests and the SLA agreement with each other and manage the contract information. In the case of the contract related to three or more servers, since a plurality of contracts is involved, the plurality of contracts is correlated by a server managing the contract information in a domain in the middle and all the contracts can be changed if a change is made.

That is, referring to FIG. 4, policy servers 20A, 20B, 20C in domains A, B, C are arranged to make the contract with each other online (procedure of process step P1). An A-B contract is made between the policy server 20A and the policy server 20B and a B-C contract is made between the policy server 20B and the policy server 20C (process step P2).

Based on the contracts, necessary device setup is performed in each domain (process step P3).

If a change is made, a relevant contract can be changed and the contract related to three or more domains can be dynamically changed (process step P4).

In the fourth technology, if the request source domain A requests a resource on a path to the domain C, two contracts are generated, which are a contract between the domain A and the domain B and a contract between the domain B and the domain C, and the middle domain B correlates contract information. That is, information generated by requests from other domains must be maintained. Therefore, it is problematic that the middle domain B must maintain an enormous amount of correlation information.

In the case of the RSVP mode of the first prior art shown in FIG. 1, this mode is difficult to achieve since it is assumed that all the routers R allowing passage of traffic must support the RSVP and scalability is insufficient when this mode is applied to a large scale network.

In the second prior art, i.e., the mode described in Japan Patent No. 3617406 shown in FIG. 2, the information of the negotiating partner is acquired from an intermediate apparatus correspondingly to the request from the customer to negotiate with another domain and it is problematic that long processing time is required until the response to the customer.

In the third prior art, i.e., the method of making the paper-based SLA (Service Level Agreement) contract as shown in FIG. 3, the usage efficiency of the resources is deteriorated when the usage status differs considerably from the estimated traffic amount, and if the contract is changed in accordance with the usage status, it takes time to change the contract and to perform setup associated with the change.

In the fourth prior art, i.e., the method of using policy server as described in Japanese Patent Application Laid-Open Publication No. 2002-74207 shown in FIG. 4, the SLA agreement and contract are basically made between two adjacent domains. That is, since the QoS guarantee for a path passing through n (three or more) network domains is associated with n−1 contracts, all the contracts must be correlated, and the server in the middle domain must maintain a large amount of information for the correlation.

### SUMMARY OF THE INVENTION

In consideration of the first to fourth prior arts, the object of the present invention is to provide a QoS guaranteeing method in multidomain network and a QoS server applied to the same that can quickly respond to the request from the customer in a large scale multidomain network to enable the end-to-end quality guarantee communication while using resources in accordance with the usage status and constraining the amount of the information managed for that purpose.

In order to achieve the above object, according to a first aspect of the present invention there is provided a QoS guaranteeing method on a network path across a plurality of domains, among QoS servers linking the domains included in each of a plurality of domains, the QoS server included in the domain defined as a QoS guaranteeing resource request source performing the steps of generating a QoS guaranteeing resource request message; sending the generated QoS guaranteeing resource request message to the QoS server managing the next domain on the path; and if resources can be reserved in all the domains on the path as a result of the QoS guaranteeing resource request of the QoS guaranteeing resource request message, managing the resources for the obtained QoS guarantee on the path from the next domain to the domain where a destination network address belongs.

In order to achieve the above object, according to a second aspect of the present invention there is provided an inter-domain linkage QoS server disposed on a network path across a plurality of domains, the inter-domain linkage QoS server associated with the transmission source domain comprising an inter-domain linkage functioning unit that generates a QoS guaranteeing resource request message, the inter-domain linkage functioning unit sending the generated QoS guaranteeing resource request message to the QoS server managing the next domain on the path; and a resource management functioning unit that manages the resources for the obtained QoS guarantee on the path from the next domain to the domain where a destination network address belongs if resources can be reserved in all the domains on the path as a result of the QoS guaranteeing resource request of the QoS guaranteeing resource request message.

According to such features of the present invention, since the present invention includes means that acquire the QoS guaranteeing resource of another domain for each destination network address and the QoS server of the request source domain acquires and manages the resource of another domain for each destination network address in advance (at the timing other than the acceptance of the request from the customer), when the QoS request across a plurality of two or more domains is received from the customer, the possibility of the acceptance can be determined without negotiating with the QoS severs of all other transit domains and the response can be quickly returned.

In the first and second aspects of the present invention, the QoS server in the middle of the path across the plurality of domains may perform the steps of, if the resource request message from a customer is transferred from the QoS server of another domain, determining from management resource information whether allocation can be achieved in a resource of an external domain identified by the request source address of the resource request message and in a resource of the own domain; and returning a notification to the request source QoS server to indicate that the resource can be reserved if the allocation can be achieved. The QoS server included in the domain defined as the QoS guaranteeing resource request source may perform the step of, when receiving from a customer a QoS guarantee request across the plurality of domains in the upward direction, i.e., the direction originated from the own domain, determining from management resource information whether allocation can be achieved in a resource of an external domain identified by the destination address of the QoS guaranteeing resource request and in a resource of the own domain, and returning a notification to the customer request to indicate that the resource can be reserved if the allocation can be achieved. The QoS server included in the domain defined as the QoS guaranteeing resource request source may perform the steps of, when receiving from a customer a QoS guarantee request across the plurality of domains in the downward direction, i.e., the direction ending at the own domain, transferring the request message to the QoS server of the ending point domain identified by the destination address of the QoS guaranteeing resource request; and returning a notification to the customer to indicate that the resource can be reserved if a response to the request message indicates that the resource can be reserved. The inter-domain linkage QoS server may perform the steps of, when receiving from a customer a bidirectional QoS guarantee request across the plurality of domains, transferring the QoS guarantee request message to the QoS server of the ending point domain identified by the destination address of the bidirectional QoS guarantee request; determining from management resource information whether a response to the bidirectional QoS guarantee request message indicates that the resource can be reserved and whether allocation can be achieved in a resource of an external domain identified by the destination address of the bidirectional QoS guarantee request and in a resource of the own domain; and returning a notification to the customer request to indicate that the resource can be reserved if the allocation can be achieved.

According to such configurations, since the request source domain manages all the resources originated in the request source, if three or more consecutive domains exist between the request source domain and the destination domain, the QoS server of the domain in the middle does not have to include information for correlating a plurality of pieces of the contract information as in the case of the fourth prior art. That is, the QoS server of the domain in the middle may include: a function for ensuring the relevant resources of the own domain; a function for determining whether or not the message must be transferred and transferring the message; and a function for returning to the QoS server of the precedent domain a response indicating that the resource can be reserved when the resource of the own domain can be reserved and the message is transferred and if the response thereof is a notification indicating that the resource can be reserved.

In the first and second aspects of the present invention, the inter-domain linkage QoS server may perform the steps of, if a managed other domain resource leading to destination network is greater than a threshold for a certain time period or more, generating a release request message for releasing a certain amount of the QoS guaranteeing resource; transferring the release request message to the QoS server of the next domain identified from the destination network; and updating the managed other domain resource if a response result of the release request message to the QoS server indicates that the resource can be reserved. The inter-domain linkage QoS server may perform the steps of, if the managed other domain resource leading to destination network is less than a threshold for a certain time period or more, generating a message for requesting a certain amount of the QoS guaranteeing resource; transferring the generated message to the QoS server of the next domain identified from the destination network; and updating the managed other domain resource if a response result of the message indicates that the resource can be reserved.

According to such configurations, since means are provided for additionally acquiring or releasing the QoS guaranteeing resource if the QoS guaranteeing resource of another domain managed in the request source domain is insufficient due to a large amount of requests from the customer or is surplus due to a small amount of requests from the customer, the resource can be reserved depending on the situation to improve the resource usage efficiency and reduce the call lost rate.

### BRIEF DESCRIPTION OF THE DRAWINGS

The above and other objects, aspects, features and advantages of the present invention will become more apparent from the following detailed description when taken in conjunction with the accompanying drawings, in which:

FIG. 1 is a diagram describing a first prior art;

FIG. 2 is a diagram describing a second prior art;

FIG. 3 is a diagram describing a third prior art;

FIG. 4 is a diagram describing a fourth prior art;

FIG. 5 shows a network configuration of a first embodiment;

FIG. 6 is a functional block of inter-domain linkage QoS servers 3A, 3B, and 3C;

FIG. 7A shows a state of the management table of the own domain resource 34;

FIG. 7B shows a state of the management table of the other domain resource 35;

FIG. 8 is a flowchart of a resource request message generating process for the QoS guarantee in the inter-domain linkage QoS server 3A;

FIG. 9 is a sequence flow among the domains A, B, and C;

FIG. 10 is a diagram describing information necessary for message generation maintained in the inter-domain linkage QoS server 3A;

FIG. 11A shows an example of the format of the QoS guaranteeing resource request message;

FIG. 11B shows contents of the resource request message generated by the inter-domain linkage QoS server 3A in accordance with the format of FIG. 11A;

FIG. 11C shows the contents of the message transferred by the inter-domain linkage QoS server 3B;

FIG. 12 shows bandwidth information maintained in the inter-domain linkage QoS server 3B of the domain B;

FIG. 13A shows a detailed operation flow of the above process (process steps P3 to P7) when the resource request message for the QoS guarantee is received in the inter-domain QoS server 3B;

FIG. 13B shows a process flow of details of the message transfer process in the flow of FIG. 13A;

FIG. 14 is a process sequence for the 1-Mbps bandwidth guarantee communication request from the customer 100a of the domain A to the terminal belonging to the transmission destination 101;

FIG. 15A shows contents of the own domain resource 34;

FIG. 15B shows contents of the other domain resource 35, which is bandwidth information of the segment to the transmission destination 101;

FIG. 16 shows network of a second embodiment;

FIG. 17 shows a state of the network of FIG. 16 where the bandwidth guarantee communication has been preprocessed for a request;

FIG. 18 shows a state of the network of FIG. 16 when the remaining bandwidth is 1 Mbps in the resource from the router R3 to the network 100C, 100D;

FIG. 19 shows a sequence in the case of receiving the bandwidth guarantee request for the downward flow from the customer;

FIG. 20 is a sequence flow describing a resource allocation process in the case of the bidirectional communication;

FIG. 21 is a flowchart of an example of a process for determining the addition and release of the resource;

FIG. 22 is a resource release message generating process flow when it is determined by the determination flow of FIG. 21 that the release of the resource is requested;

FIG. 23A shows an example of the release request message format;

FIG. 23B shows a state of the release request transfer message format with the gateway address of the release request message rewritten;

FIG. 24A shows a flow of a process in the inter-domain linkage QoS server 3B when receiving the release request; and

FIG. 24B shows details of the transfer process (step S455) in the process of FIG. 24A.

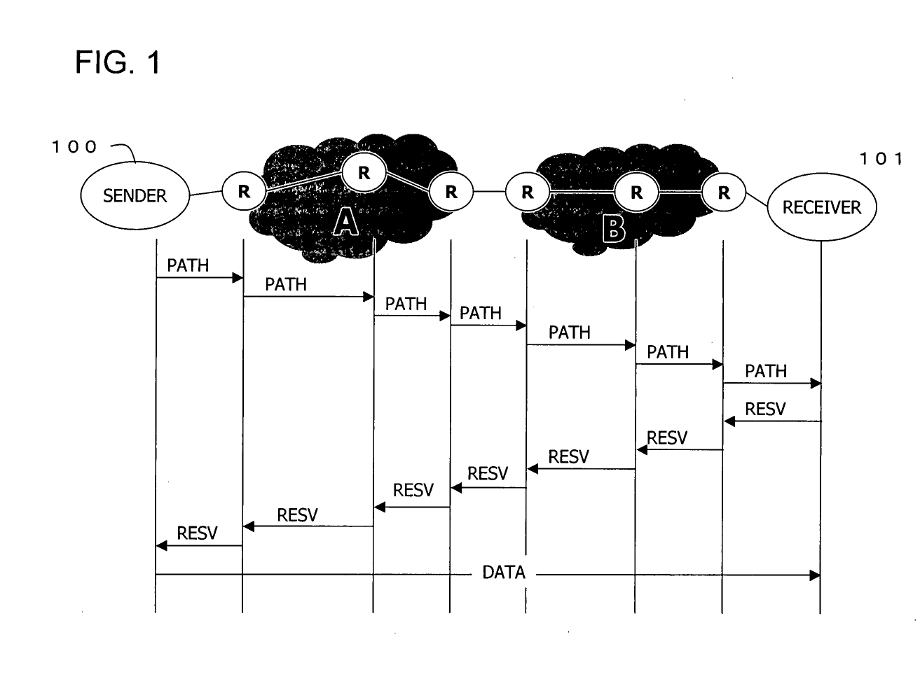

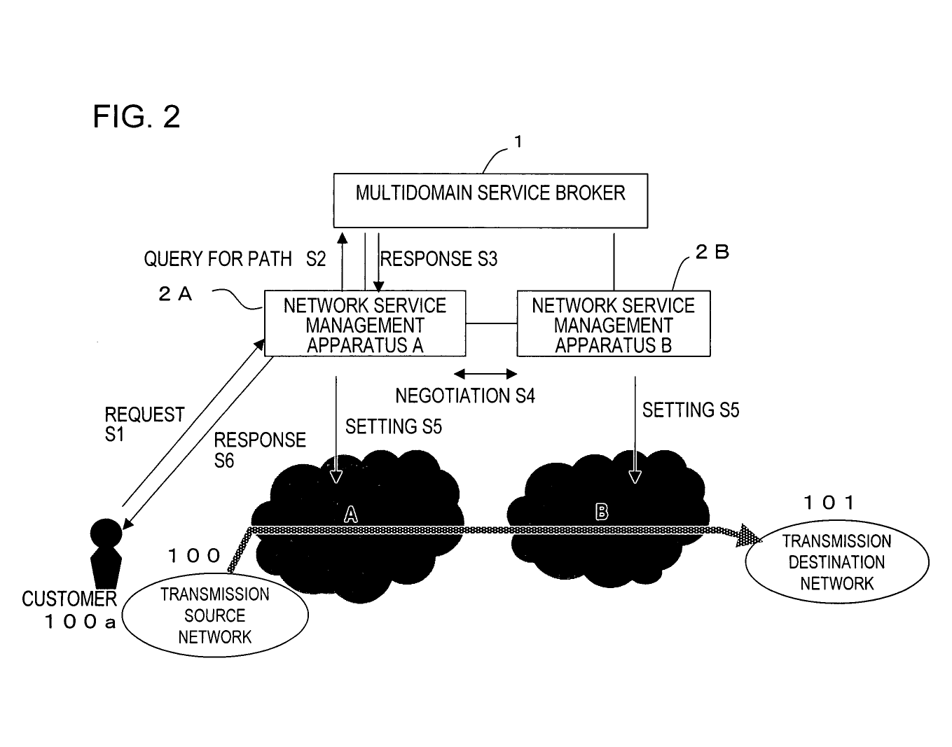

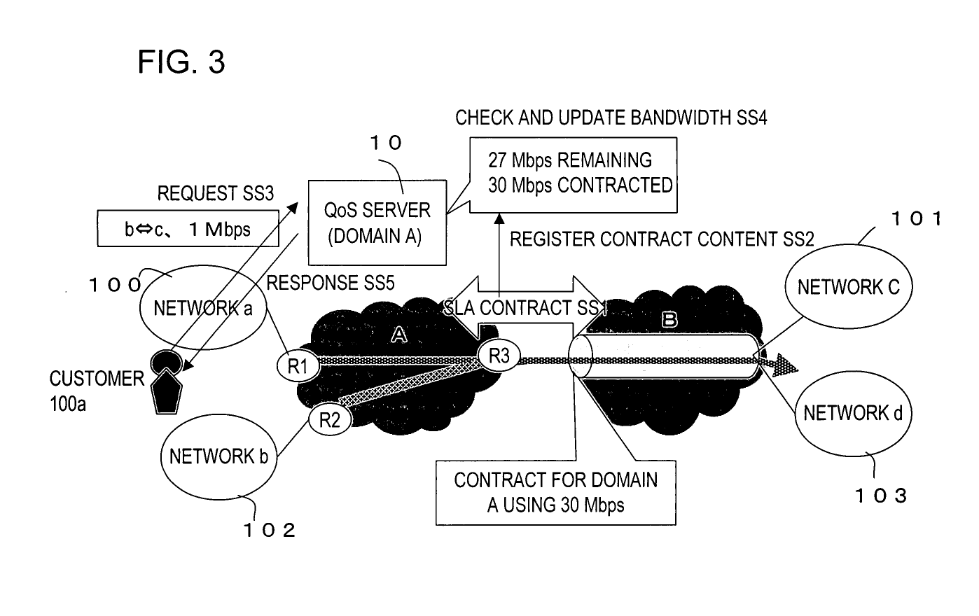

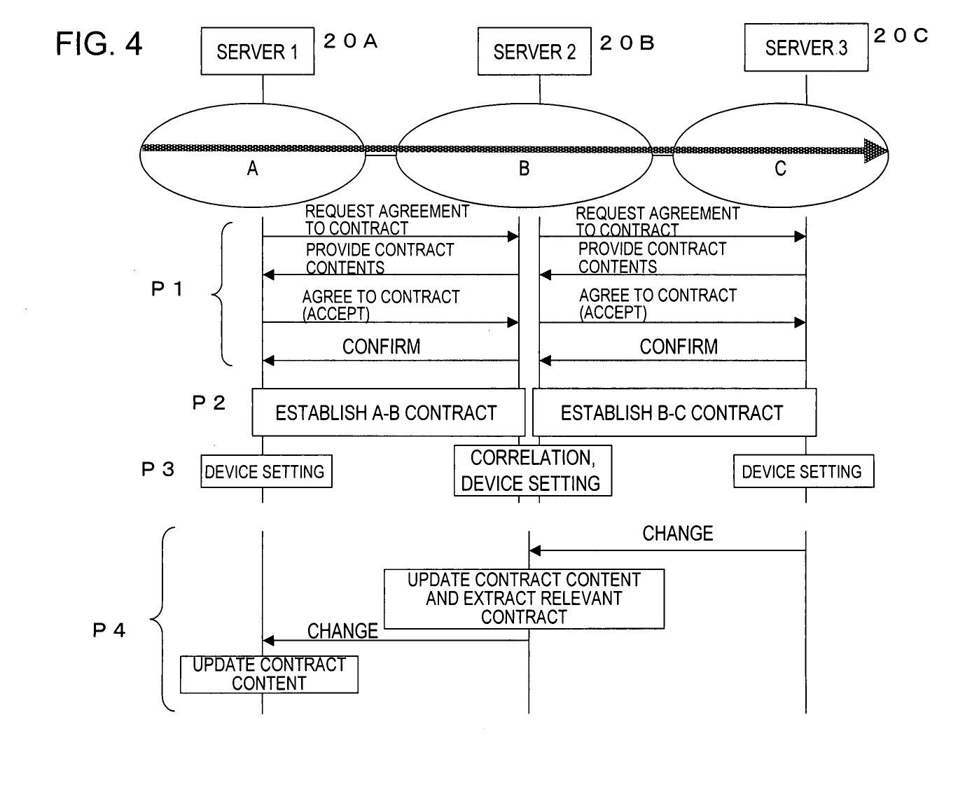

### DESCRIPTION OF THE PREFERRED EMBODIMENTS

Embodiments of the present invention will hereinafter be described with reference to the accompanying drawings. The embodiments are for the purpose of understanding the present invention and do not limit the technical scope of the present invention.

### First Embodiment

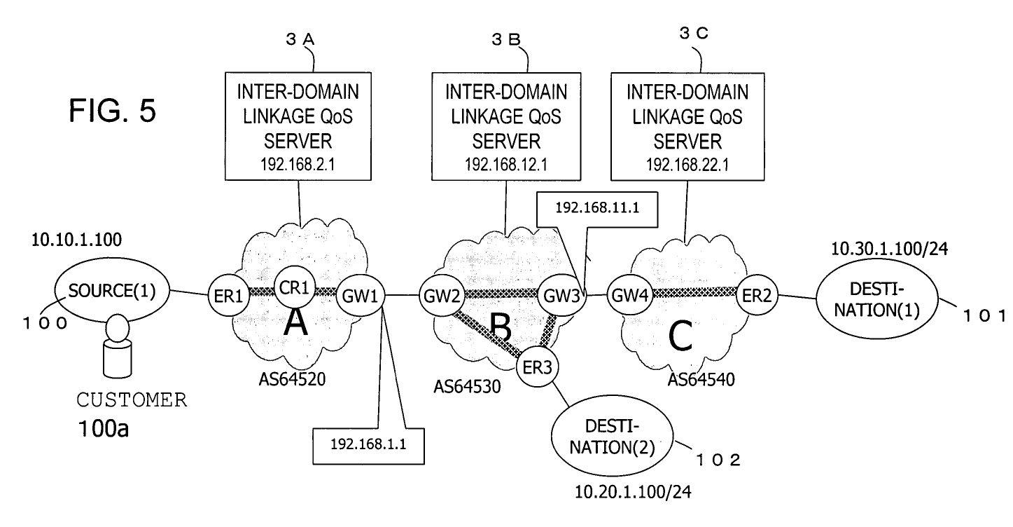

FIG. 5 shows a network configuration of a first embodiment. Network is assumed to be constituted by linking domains A, B, and C.

(Method of Acquiring Resource across Three Domains by Request Source)

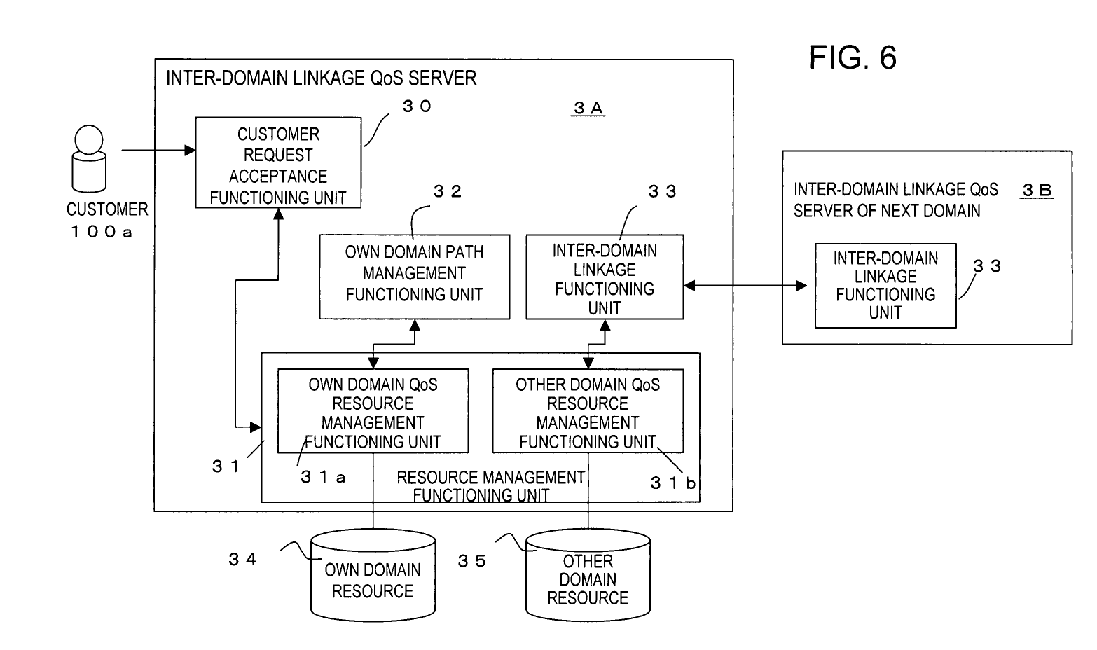

FIG. 6 is a functional block of inter-domain linkage QoS servers 3A, 3B, and 3C, which have a common configuration constituted by a customer request acceptance functioning unit 30, a resource management functioning unit 31, an own domain path management functioning unit 32, and an inter-domain linkage functioning unit 33.

With regard to own domain resource 34, a path and a bandwidth are determined by the own domain path management functioning unit 32 for each segment and managed by an own domain QoS resource management functioning unit 31a. In the example shown in FIG. 5, a path from an edge router ER1 to a gateway GW1 is ER1-CR1-GW1 passing through a center router CR1 and it is assumed that 10 Mbps are allocated to the pass for guaranteeing a bandwidth. A conventional optimum resource allocation algorithm, etc. can be applied to the methods of determining the path and determining the resource allocation amount.

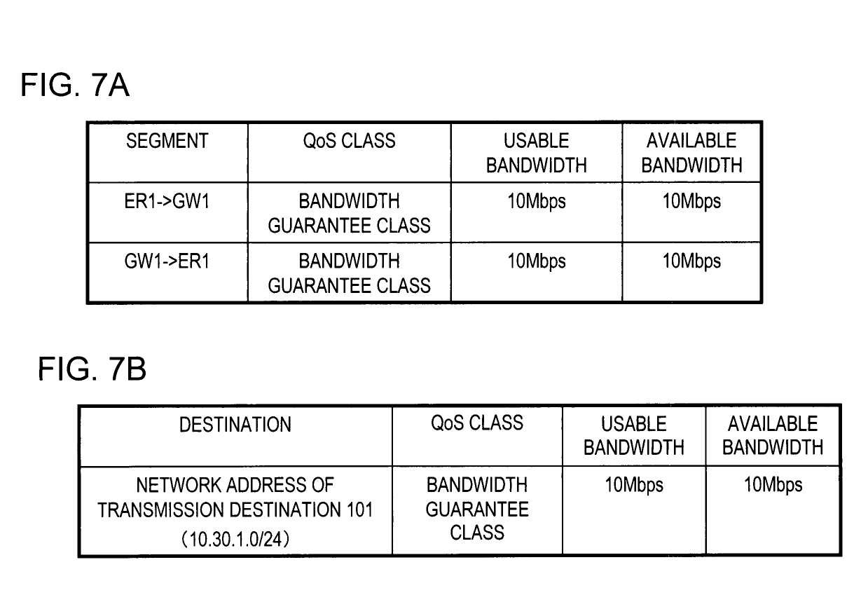

Therefore, the own domain QoS resource management functioning unit 31a manages the 10-Mbps bandwidth guaranteeing resource on ER1-GW1. The own domain QoS resource management functioning unit 31a creates a management table shown in FIG. 7A in the own domain resource 34.

In the upward and downward direction of the segment of ER1 and GW1, a QoS class is a bandwidth guaranteeing class and 10 Mbps is reserved for a usable bandwidth. Before use, an available bandwidth is the same as the usable bandwidth.

In other domains B and C, it is assumed that the bandwidth guaranteeing resources are reserved in respective own domain segments as well. For example, the domain B reserves and manages respective 50-Mbps resources between a gateway GW2 and a gateway GW3, between the gateway GW2 and an edge router ER3, and between the edge router ER3 and the gateway GW3.

The domain C reserves and manages 50 Mbps between a gateway GW4 and an edge router ER2.

The domain A determines that it is desirable to reserve a 10-Mbps resource in the communication from a transmission source (SOURCE (1)) 100 to a transmission destination (DESTINATION (1)) 101 to perform a bandwidth guarantee service. In a method of triggering the determination, for example, an operator may determine a segment and a bandwidth of the bandwidth guarantee service in advance, which are set in the inter-domain linkage QoS server 3A.

For the domain A reserving the 10 Mbps resource leading to the transmission destination 101, i.e., the resources for the QoS guarantee on the path from the gateway GW1 of the domain A through the domain B to the domain C, the inter-domain linkage functioning unit 33 of the inter-domain linkage QoS server 3A creates a QoS guaranteeing resource request message.

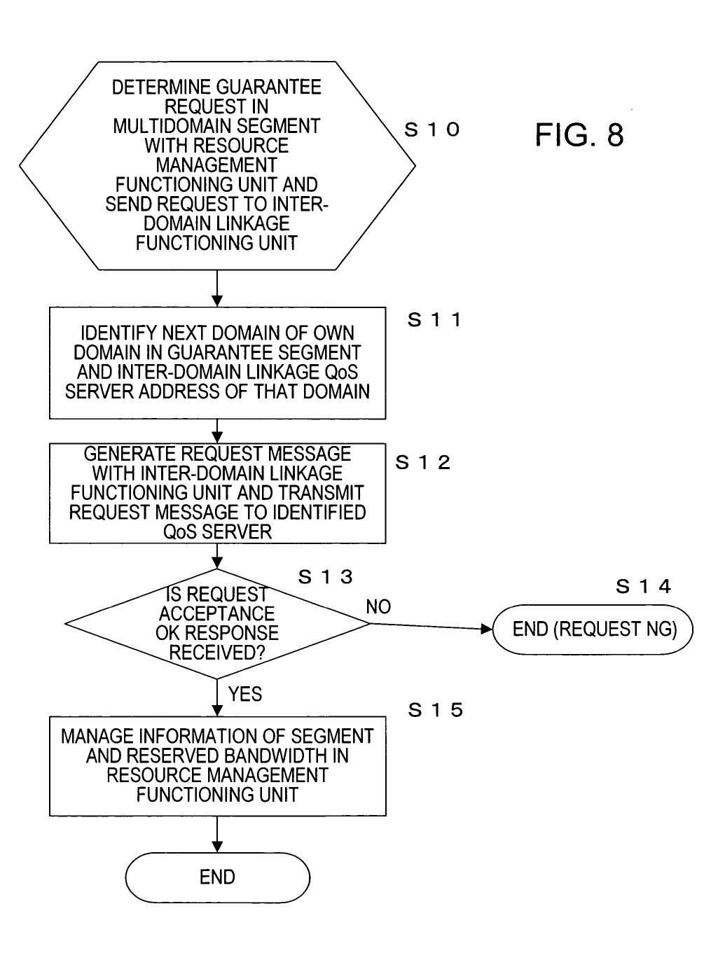

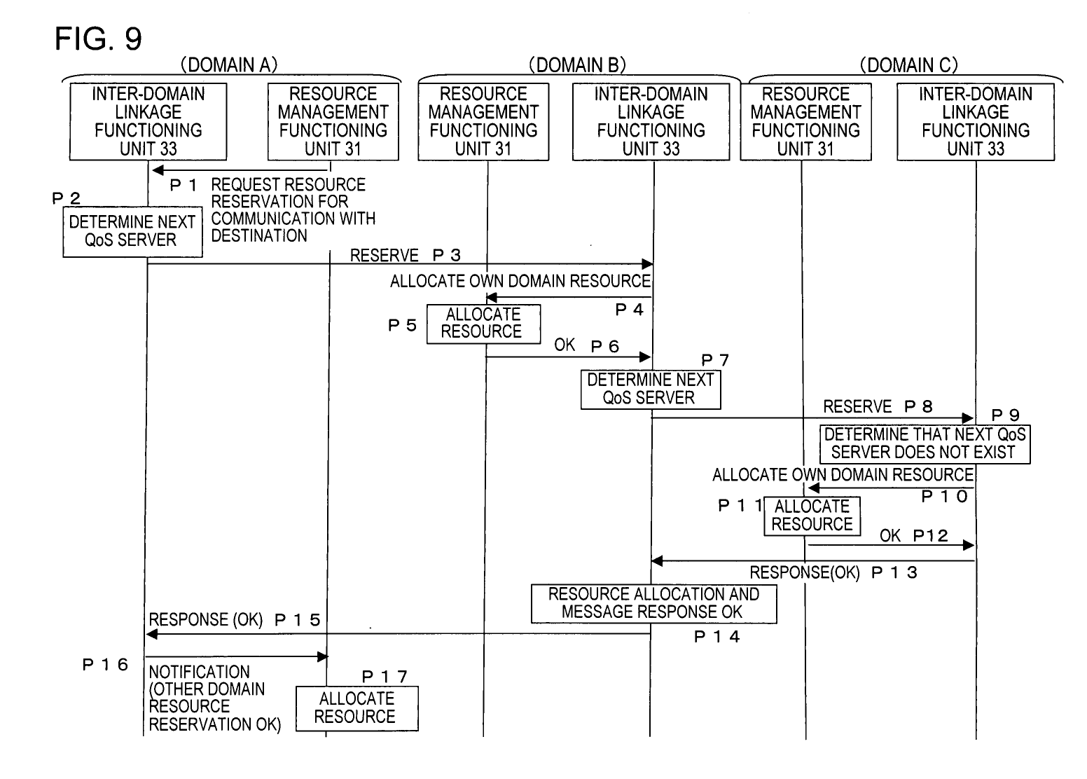

FIG. 8 is a flowchart of a resource request message generating process for the QoS guarantee in the inter-domain linkage QoS server 3A. FIG. 9 is a sequence flow among the domains A, B, and C.

First, the resource management functioning unit 31 of the inter-domain linkage QoS server 3A determines a guarantee request in a multidomain segment and sends the request to the inter-domain linkage functioning unit 33 (FIG. 8: step S10, FIG. 9: process step P1).

This request includes information indicating that this is a request relating to a segment from the gateway GW1 to the transmission destination 101 and that 10 Mbps are desired to be reserved in the bandwidth guarantee class.

The inter-domain linkage QoS server 3A manages information of the destination of the message in advance, which is information indicating that the domain B is the next domain for reaching the transmission destination 101 and the address of the inter-domain linkage QoS server 3B. The inter-domain linkage QoS server 3A may not know that the transmission destination 101 belongs to the domain C.

Therefore, the inter-domain linkage QoS server 3A identifies the domain B, which is the next domain of the own domain in the guarantee segment, and the address of the corresponding inter-domain linkage QoS server 3B (FIG. 8: step S11, FIG. 9: process step P2).

Information necessary for generating the message is maintained in the inter-domain linkage QoS server 3A in advance.

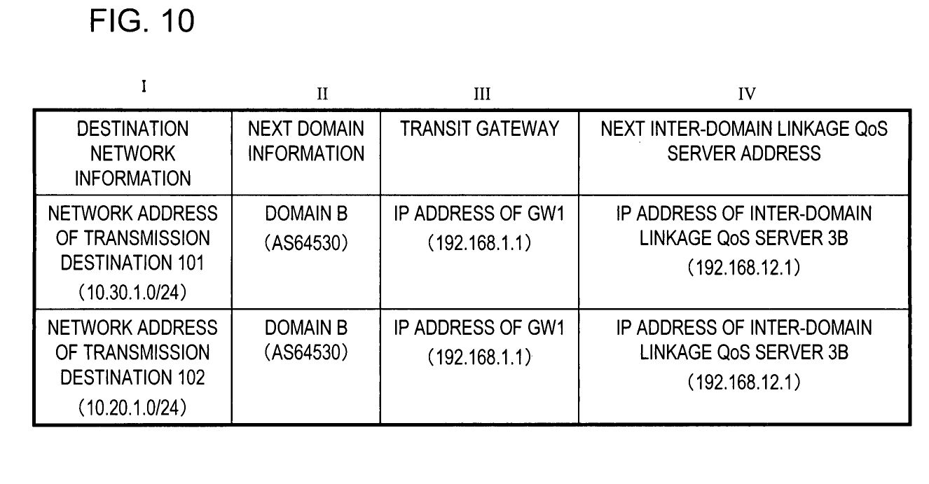

For example, as shown in FIG. 10, the inter-domain linkage QoS server 3A includes destination network information I, own domain information II, transit gateways III, and inter-domain linkage QoS server addresses IV.

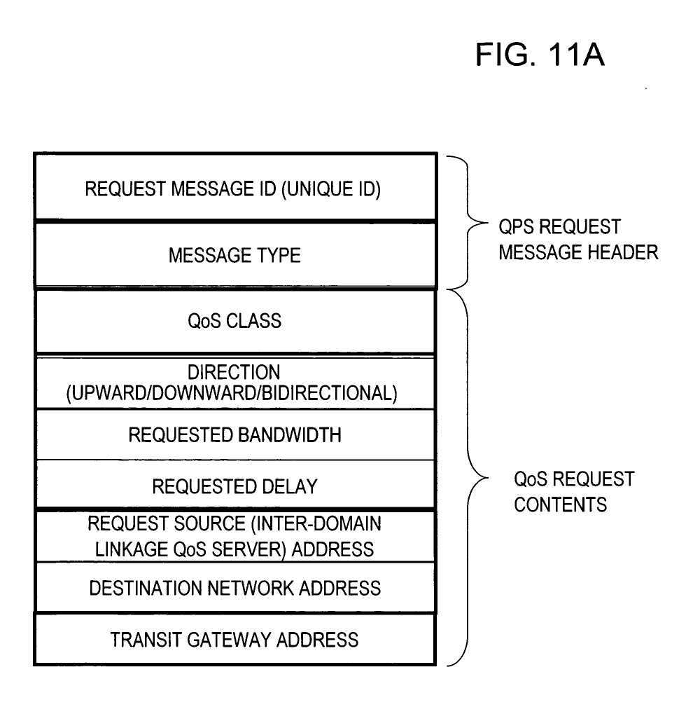

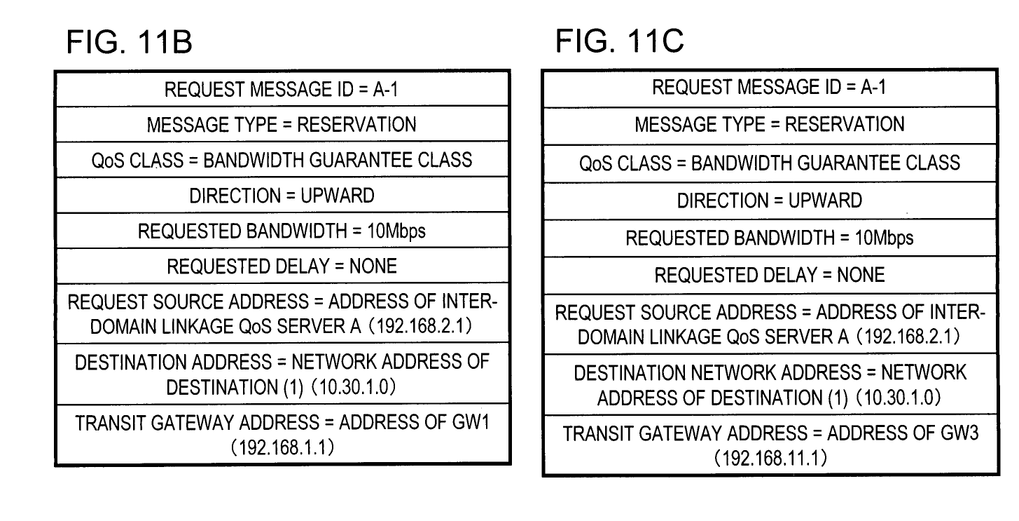

FIG. 11A shows an example of the format of the QoS guaranteeing resource request message generated based on the aforementioned information necessary for the message generation. A QoS request message header written into the message includes an ID differentiating the QoS request message and QoS request contents are written into the message correspondingly to the differentiated QoS request message.

FIG. 11B is contents of the resource request message generated by the inter-domain linkage QoS server 3A in accordance with the format of FIG. 11A.

The inter-domain linkage functioning unit 33 of the inter-domain linkage QoS server 3A sends the resource request message to the adjacent inter-domain linkage QoS server 3B (FIG. 8: step S12, FIG. 9: process step P3).

Therefore, the inter-domain linkage functioning unit 33 of the inter-domain linkage QoS server 3B in the domain B receives the resource request message shown in FIG. 11B from the inter-domain linkage QoS server 3A.

From the fact that the gateway GW1 is connected with the gateway GW2 and that the domain C is the next domain for reaching the transmission destination 101 and is connected with the gateway GW3, the inter-domain linkage QoS server 3B checks the resource management functioning unit 31 to determine whether a resource ranging from the gateway GW2 to the gateway GW3 exists or not (process step P4) and, if a corresponding resource exists, allocation is performed for the resource (process step P5).

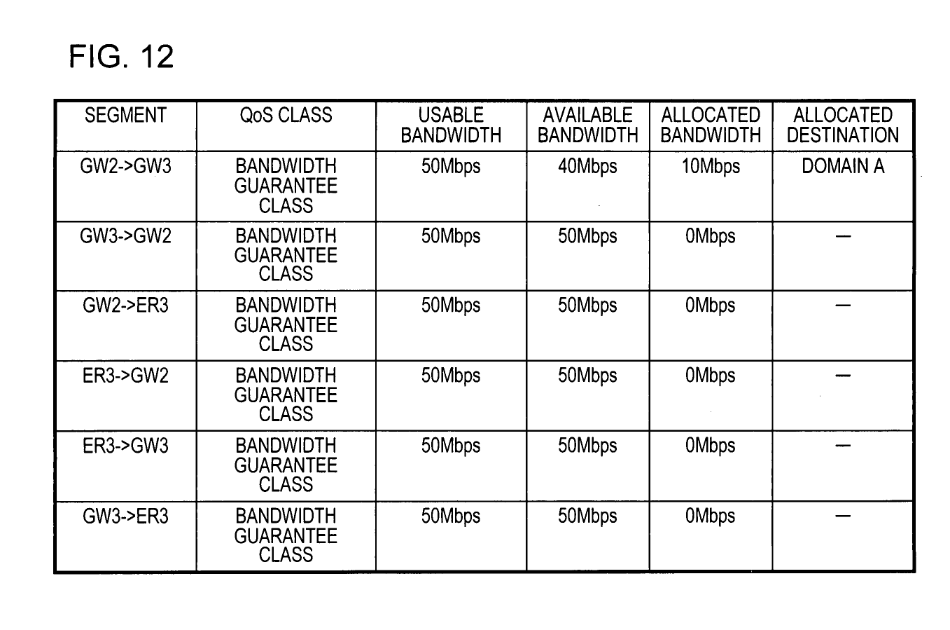

FIG. 12 is bandwidth information maintained in the inter-domain linkage QoS server 3B of the domain B, which is updated in the own domain resource 34. That is, the available bandwidth of the bandwidth guarantee class from the gateway GW2 to the gateway GW3 is updated in the domain B from 50 Mbps to 40 Mbps to allocate a capacity of 10 Mbps in accordance with the request from the domain A.

The resource management functioning unit 31 of the domain B performs the resource allocation in this way and notifies the inter-domain linkage functioning unit 33 that the resource can be reserved (hereinafter, represented by OK) (process step P6).

To connect with the transmission destination 101, the inter-domain linkage QoS server 3B of the domain B determines the inter-domain linkage QoS server 3C of the next domain C (process step P7) and transfers the resource reservation request message to this server (process step P8).

The contents of the transferred message are rewritten to indicate that this request is relevant to the segment from the gateway GW3 to the transmission destination 101.

FIG 11C is the contents of the message transferred by the inter-domain linkage QoS server 3B and the gateway has been rewritten (GW1→GW3) as compared to the message sent from the inter-domain linkage QoS server 3A (FIG. 11B).

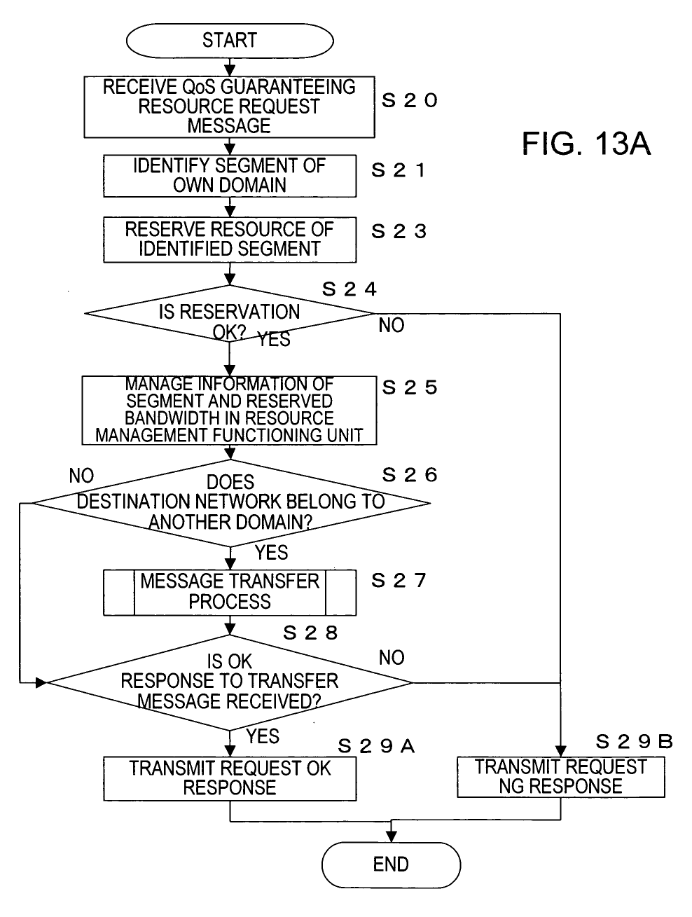

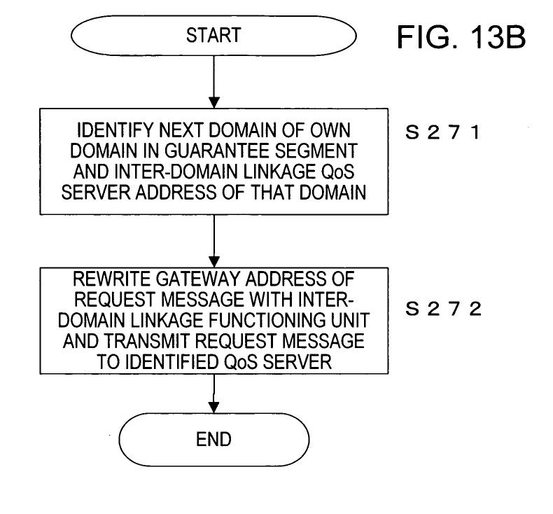

FIGS. 13A and 13B show detailed operation flows of the above process (process steps P3 to P7) when the resource request message for the QoS guarantee is received in the inter-domain QoS server 3B.

In FIG. 13A, when the QoS guaranteeing resource request message is received from the inter-domain linkage QoS server 3A (step S20), the inter-domain linkage functioning unit 30 identifies the segment of the own domain (step S21) . That is, the segment from the gateway GW2 to the gateway GW3 is identified.

A resource reservation process is performed for the identified segment (step S22). If the resource cannot be reserved in the identified segment, an NG response to the request is returned (step S29B).

On the other hand, if it is determined that the resource can be reserved at step S24, the resource management functioning unit 31 manages the information of the segment and the reserved bandwidth in the own domain resource 34 (step S25).

It is then determined whether the destination network belongs to another domain or not (step S26), and if the destination network does not belong to another domain (step S26, NO), a request OK response is transmitted to the inter-domain linkage QoS server 3A (step S29A).

If it is determined that the destination network belongs to another domain at step S26 (step S26, YES), a message transfer process is performed (step S27). This message transfer process is performed in accordance with the process flow shown in FIG. 13B.

In FIG. 13B, the next domain of the own domain is identified in the guarantee segment, and the address of the inter-domain linkage QoS server in that domain is identified, which is the address of the inter-domain linkage QoS server C in this embodiment (step S271).

The inter-domain linkage functioning unit 33 rewrites the gateway address of the request message in the message transfer format shown in FIG. 11C (to the gateway GW3 in this embodiment) and transmits the message to the identified inter-domain linkage QoS server 3C (step S272).

Referring to the flow of FIG. 13A again, if the OK response to the transfer message from the inter-domain linkage QoS server 3C (step S28, YES), an OK response is transmitted to the inter-domain linkage QoS server 3A, which is the request source (step S29A).

Referring to FIG. 9 again, since the transmission destination 101 belongs to the own domain, the inter-domain linkage functioning unit 33 of the inter-domain linkage QoS server 3C in the domain C determines that the message transfer is not needed (process step P9). The inter-domain linkage functioning unit 33 checks the resource management functioning unit 31 to determine whether or not a resource of the own domain exists which ranges from the gateway GW4 connected with the gateway GW3 to the edge router ER2 connected with the transmission destination 101 (process step P10) and performs the allocation (process step P11).

When receiving an allocation notification (process step P12), the inter-domain linkage functioning unit 33 of the inter-domain linkage QoS server 3C returns the OK response to the inter-domain linkage QoS server 3B (process step P13).

The inter-domain linkage QoS server 3B checks that the resource allocation is OK in the own domain and that the response from the inter-domain linkage QoS server 3C is OK as well (process step P14) and returns the OK response to the inter-domain linkage QoS server 3A (process step P15, FIG. 13A: step S29A).

When the inter-domain linkage functioning unit 33 of the inter-domain linkage QoS server 3A receives the message indicating that the request acceptance is OK from the inter-domain linkage QoS server 3B (FIG. 8: step S13, YES, FIG. 9: process step P16), an other domain QoS resource management functioning unit 31b of the resource management functioning unit 31 manages the acquired 10-Mbps resource from the gateway GW1 to the transmission destination 101 as an other domain resource 35 (FIG. 8: step S15, FIG. 9: process step P17). FIG. 7B shows the state of the management table of the other domain resource 35 at this point of time.

As described above, the 10-Mbps resource leading to the transmission destination 101 is reserved in the domain A. If the customer 100a requests 1-Mbps bandwidth guarantee communication to a terminal belonging to the transmission destination 101 in this situation, the operation is as follows.

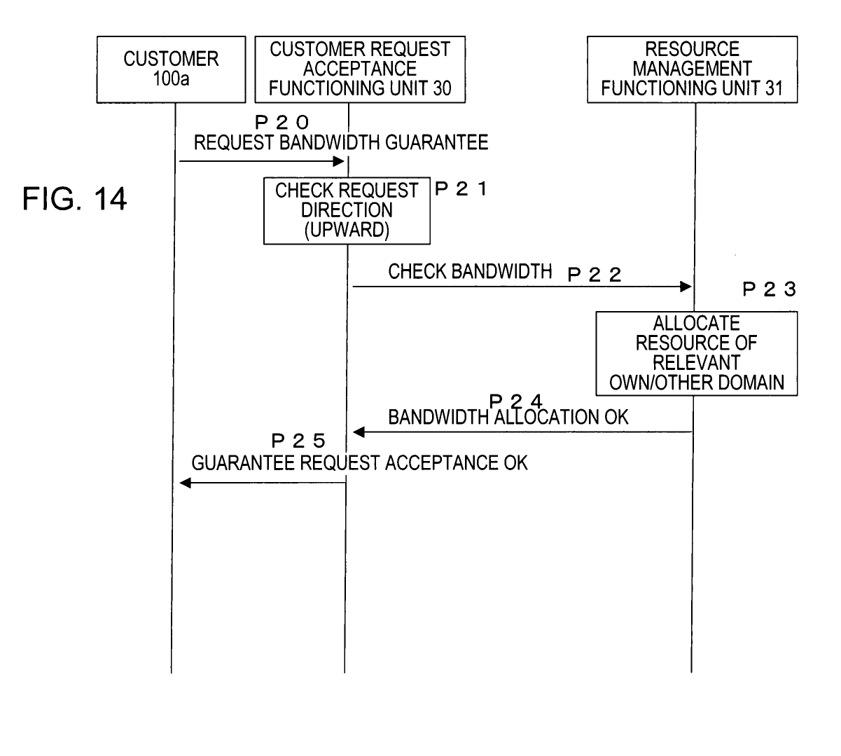

FIG. 14 is a process sequence for the 1-Mbps bandwidth guarantee communication request from the customer 100a of the domain A to the terminal belonging to the transmission destination 101.

The bandwidth guarantee request from the customer 100a is accepted by the customer request acceptance functioning unit 30 of the inter-domain linkage QoS server 3A (process step P20).

The customer request acceptance functioning unit 30 checks the requested direction and segment to confirm that the own domain is the transmission source (Source) and that the direction is the upward direction (process step P21). The bandwidth of the requested segment is checked in the resource management functioning unit 31 (process step P22).

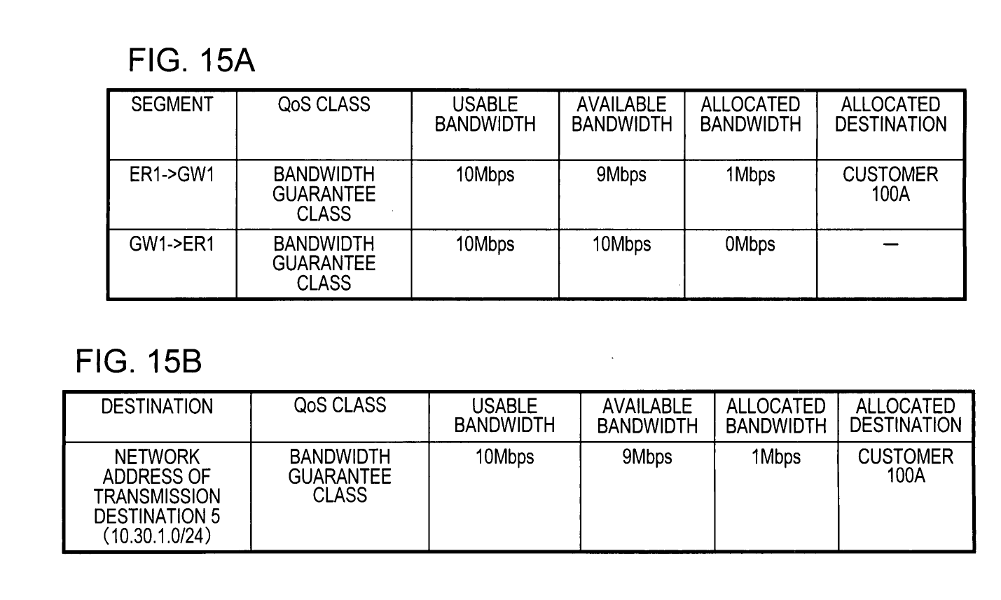

As shown in FIGS. 15A and 15B, the resource management functioning unit 31 manages the own domain resource 34 and the other domain resource 35, which is bandwidth information of the segment to the transmission destination 101.

From the own and other domain resources 34 and 35, it is found out that the ER1 is the edge router connected from the terminal address of the customer 100a , and from the adjacent domain information shown in FIG. 10, which is maintained in the inter-domain linkage QoS server 3A, it is found out that the transmission destination 101 is reached via the gateway GW1.

In this way, the resource management functioning unit 31 checks whether the 1-Mbps bandwidth of the bandwidth guarantee class can be allocated to the segment from the edge router ER1 to the gateway GW1 of the own domain.

It is also checked whether 1 Mbps of the bandwidth guarantee class can be allocated to the segment from the GW1 to the transmission destination 101 of other domains (process step P23). Since the allocation can be performed, the allocation is performed for the relevant own and other domain resources 34 and 35. Information of the allocated bandwidth and the allocation destination is added to the resource information to update the available bandwidth. Since 1 Mbps is requested in this case, the available bandwidth is reduced to 9 Mbps. This state is updated and reflected in the own and other domain resources 34 and 35.

FIG. 15A is the bandwidth information of the own domain resource 34 updated and registered after the bandwidth allocation for the customer 100a . Similarly, FIG. 15B is the bandwidth information of the other domain resource 34 updated and registered after the bandwidth allocation for the customer 100a.

The guarantee request acceptance OK is returned from the customer request acceptance functioning unit 30 to the customer 100a (process steps P24, P25).

As described above, since the resource allocated to the quality guarantee request is prepared for each destination network, when requested from the customer 100a , the request can be quickly responded by allocating the resource that has been reserved.

Second Embodiment

In a second embodiment, description will be made of increasing and decreasing the allocated bandwidth of the resource across two domains.

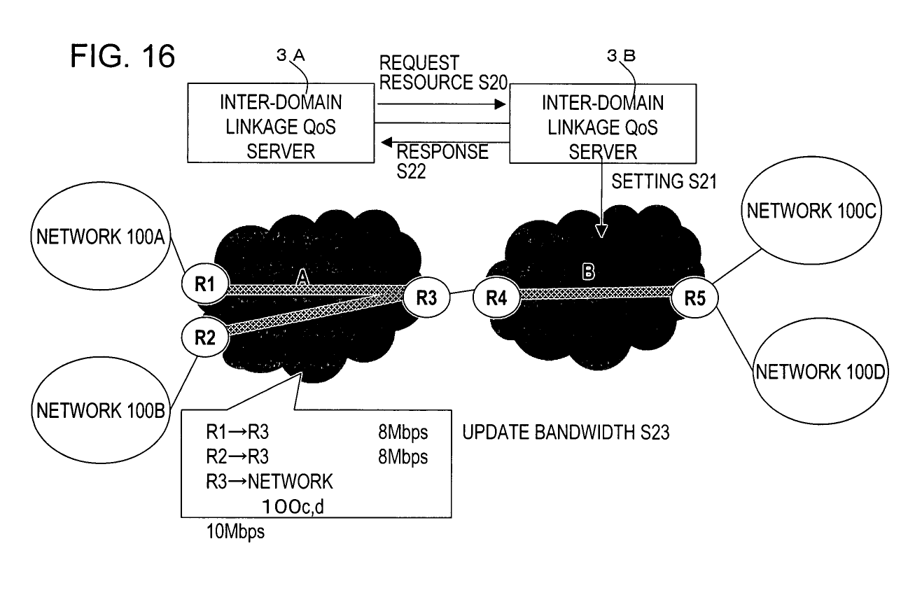

In the second embodiment, it is assumed that network is as shown in FIG. 16.

The domain A has reserved the own domain resource, which is 8-Mbps bandwidth guaranteeing resources for a segment from a router R1 linked with network 100A to a router R3 and for a segment from a router R2 linked with network 100B to the router R3. A 10-Mbps bandwidth has been acquired for a segment from the router R3 to network 100C, 100D.

The domain A uses the inter-domain linkage QoS server 3A in advance to perform a QoS guaranteeing resource request to the inter-domain linkage QoS server 3B of the domain B (S20) and reserves a bandwidth between a router R4 and a router R5 for the QoS guarantee communication with the network 100C, 100D (step S21).

The inter-domain linkage QoS server 3A receives the setting response from the inter-domain linkage QoS server 3B (step S22) and updates the own and other domain resources 34, 35 (step S23).

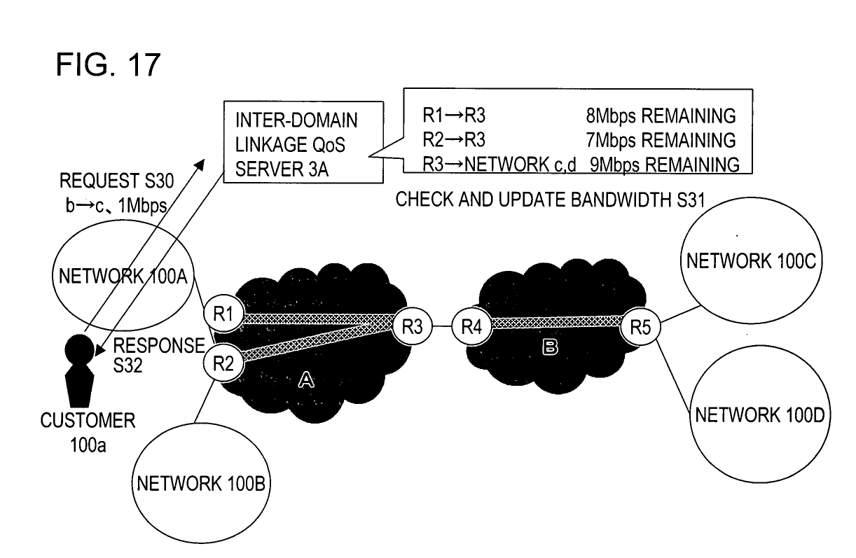

In the state after such preprocessing, it is assumed that 1-Mbps bandwidth guarantee communication with the network 100C is requested by the customer 100a of the domain A, who connects to the network A, as shown in FIG. 17 (step S30).

The inter-domain linkage QoS server 3A allocates 1 Mbps from the resource of the segment from the router R2 to the router R3 and allocates 1 Mbps from the resource of the segment from the router R3 to the network 100C, 100D (step S31). Therefore, the remaining bandwidths of the segments are 7 Mbps and 9 Mbps.

Since the allocation can be performed, the customer 100a is notified that the QoS guarantee communication can be performed.

It is then assumed that a 5-Mbps request from the network 100A to the network 100D is accepted and that a 4-Mbps request from the network 100B to the network 100C is accepted as the request from the customer increases.

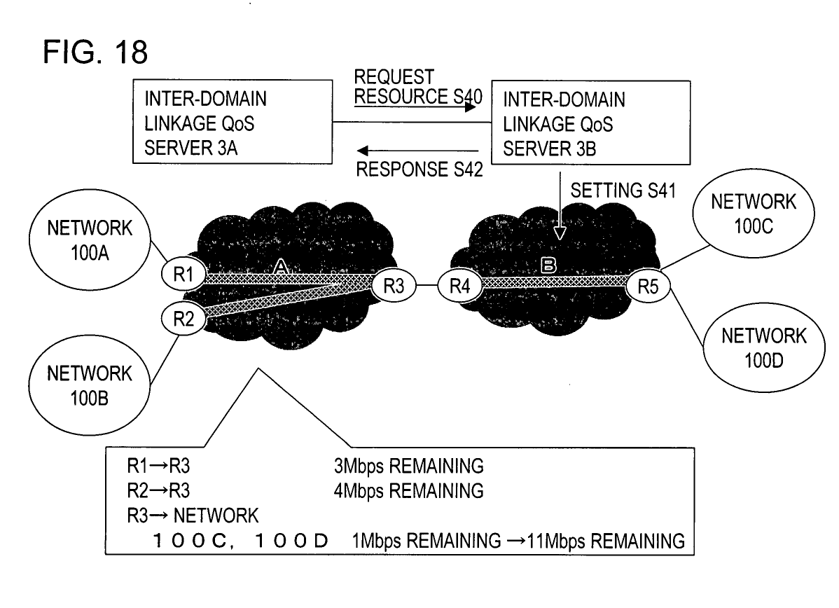

As shown in FIG. 18, the remaining bandwidth is 1 Mbps in the resource from the router R3 to the network 100C, 100D.

Therefore, the resource management functioning unit 31 of the inter-domain linkage QoS server 3A compares the remaining bandwidth with a predetermined threshold and determines a 10-Mbps additional request for the bandwidth guaranteeing resource leading to the network 100C, 100D. A request message is generated and sent to the inter-domain linkage QoS server 3B (step S40). As is the case with the procedure shown in FIG. 16, the bandwidth in the domain B is reserved for the domain A (step S41), and the inter-domain linkage QoS server 3A receives the OK response from the inter-domain linkage QoS server 3B (step S42).

The inter-domain linkage QoS server 3A updates the information of the other domain resource 35 of the resource management functioning unit 31. That is, the remaining bandwidth is defined as 11 Mbps for the resource of the segment from the router R3 to the network 100C, 100D (FIG. 18).

As described above, the resource can be added flexibly depending on the request condition and, consequently, the resource can be utilized efficiently.

Third Embodiment

In a third embodiment, description will be made of a bandwidth guarantee request for the downward flow from the customer 100a.

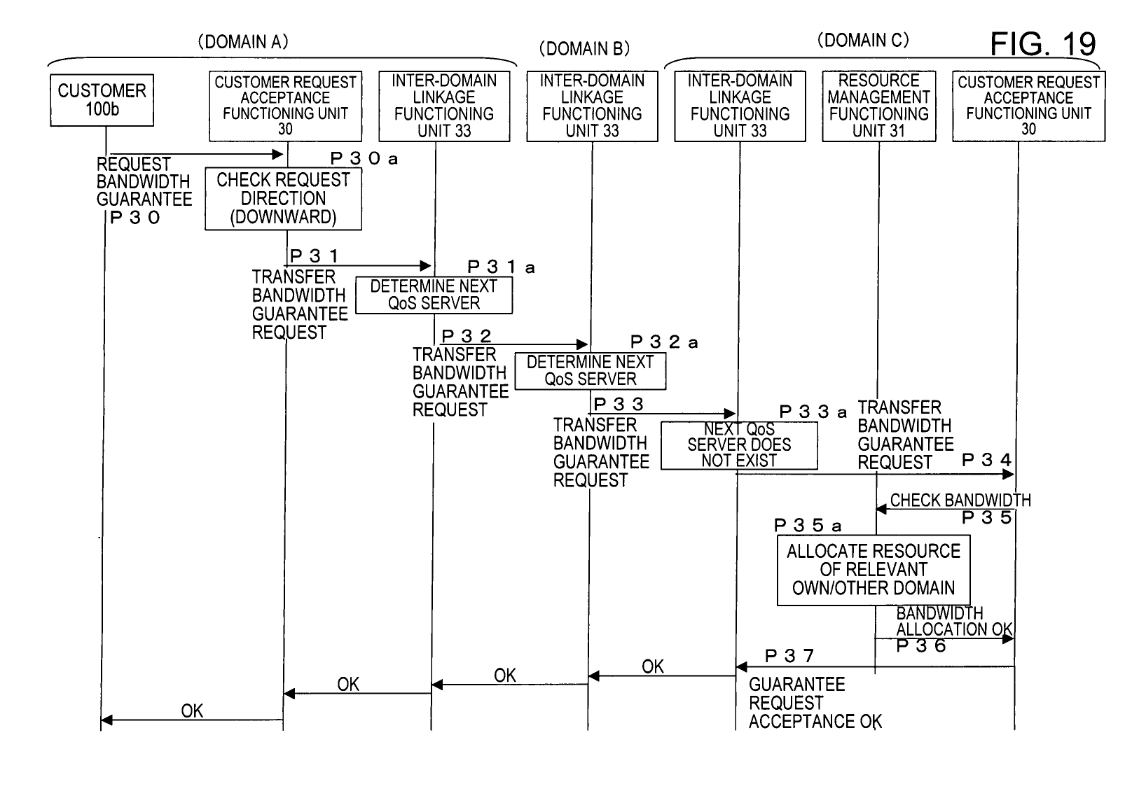

FIG. 19 shows a sequence in the case of receiving the bandwidth guarantee request for the downward flow from the customer. As shown in the first embodiment, the present invention reserves the guaranteeing resource in the multidomain environment in the upward direction (direction when the own domain is the transmission source). Therefore, if a request is made for the downward direction, a flow must be guaranteed such that a transmission source (Source) is defined as a domain where the communication counterpart of the requesting customer (customer contracted with the domain A) belongs.

That is, if the communication counterpart belongs to the domain C, the inter-domain linkage QoS server C performs the bandwidth allocation. Therefore, the guarantee in the downward direction can be supported by executing the following process.

To utilize the guarantee service, a customer 100b issues a bandwidth guarantee request to the customer request acceptance functioning unit 30 of the inter-domain linkage QoS server 3A in the own domain (process step P30). The customer request acceptance functioning unit 30 checks the requested direction (process step P30), and since the direction is the downward direction, the request is transferred to the inter-domain linkage functioning unit 33 (process step P31).

The inter-domain linkage functioning unit 33 determines the QoS server of the next domain from the requested guarantee segment (process step P31a) and transfers the request to the inter-domain linkage QoS server 3B (process step P32).

Since the own domain is not the ending point, the inter-domain linkage functioning unit 33 of the inter-domain linkage QoS server 3B further determines the QoS server of the next domain from the requested guarantee segment (process step P32a) and transfers the request to the inter-domain linkage QoS server 3C (process step P33).

The inter-domain linkage functioning unit 33 of the inter-domain linkage QoS server 3C confirms that the own domain is the ending point from the requested guarantee segment (process step P33a) and sends the request to the customer request acceptance functioning unit 30 (process step P34).

The customer request acceptance functioning unit 30 checks a bandwidth in the resource management functioning unit 31 in accordance with the contents of the request (process step P35). There source management functioning unit 31 allocates the relevant own domain resource 34 and other domain resource 35 to satisfy the request (process step P35a) . When the allocation is completed, OK is returned to the customer request acceptance functioning unit 30 (process step P36).

The guarantee request acceptance OK is sent from the customer request acceptance functioning unit 30 to the inter-domain linkage functioning unit 33 (process step P37) and, therefore, the guarantee request acceptance OK response is sequentially returned from the inter-domain linkage QoS server 3C to 3B and 3A.

Finally, the request acceptance OK is returned to the customer 100b.

With the above procedure, the guarantee in the downward direction can be achieved by transferring the request to the QoS server of the domain where a terminal or server defined as the transmission source (Source) belongs and by performing the bandwidth allocation in the transfer destination domain.

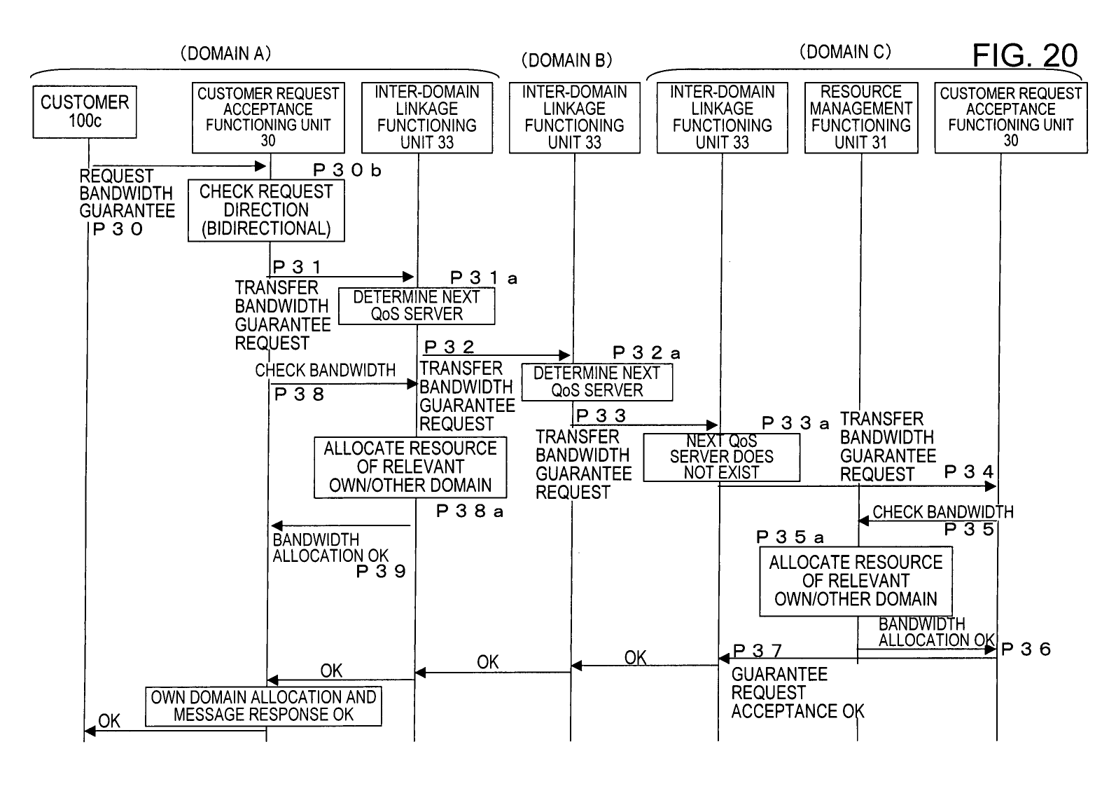

The bidirectional communication can be achieved by performing the both upward and downward processes. FIG. 20 is a sequence flow describing a resource allocation process in the case of the bidirectional communication. Unlike FIG. 19, the customer request acceptance functioning unit 30 of the QoS server 3A in the domain A receives the bandwidth guarantee request from a customer 100c and confirms that the requested direction is bidirectional (process step P30b) . In the downward direction, the process is performed in accordance with the sequence process shown in FIG. 19. At the same time, in the upward direction, the bandwidth is checked in the resource management functioning unit 31 of the own domain A (process step P38).

The resource management functioning unit 31 allocates the relevant own/other domain resources in the upward direction (process step P 38a) and returns a bandwidth allocation OK notification to the customer request acceptance functioning unit 30 (process step P39).

Therefore, the customer request acceptance functioning unit 30 checks the bandwidth allocation OK notification from the resource management functioning unit 31 of the own domain and the bandwidth allocation OK notification of the downward direction returned sequentially from the inter-domain linkage QoS server 3C to 3B and 3A (process step P39a) and returns OK of the bandwidth guarantee request to the customer 100c.

For the dynamic QoS guarantee in the inter-domain linkage QoS server, a request must be made for additional resource acquirement or a release process must be performed for a resource that is no longer used.

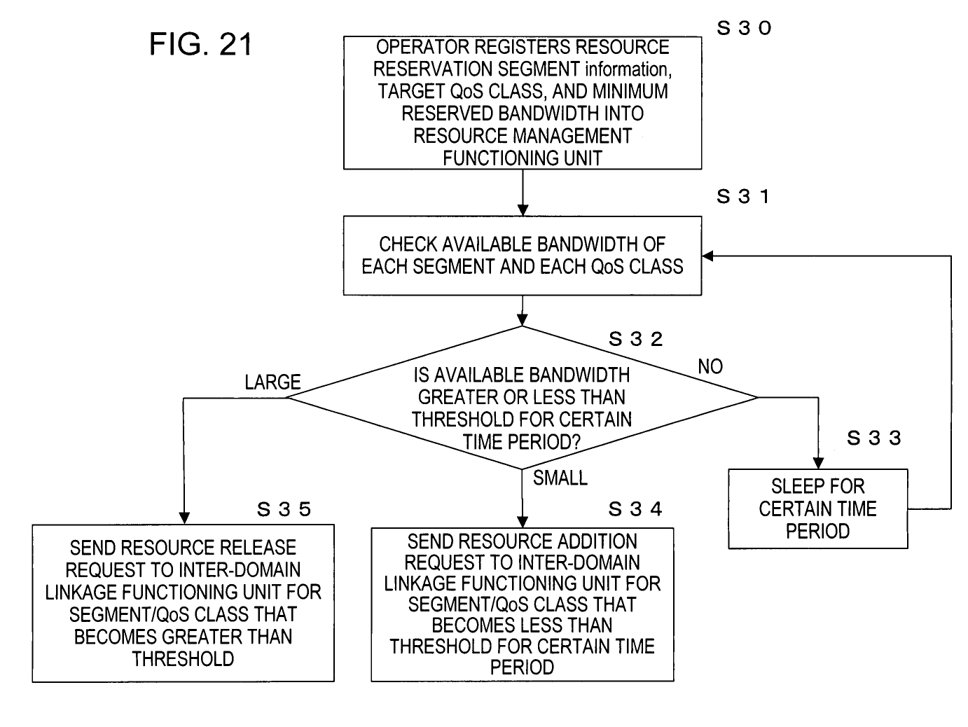

FIG. 21 is a flowchart of an example of a process for determining the addition and release of the resource.

In FIG. 21, an operator registers resource reservation segment information, a target QoS class, and a minimum reserved bandwidth into the resource management functioning unit 31 (step S30).

The available bandwidth is checked for each segment and each QoS class at regular intervals on a timely basis (step S31). It is determined whether the available bandwidth is greater or less than threshold for a certain time period (step S32). If the available bandwidth is within the range of the threshold for the certain time period, the state is maintained until the next timing (step S33).

If the available bandwidth is less than the threshold for the certain time period, the inter-domain linkage functioning unit 33 is requested to add the resource to the segment/QoS class having the available bandwidth less than the threshold for the certain time period (step S34). On the other hand, if the available bandwidth is greater than the threshold for the certain time period, the inter-domain linkage functioning unit 33 is requested to release the resource from the segment/QoS class having the available bandwidth greater than the threshold for the certain time period (step S35).

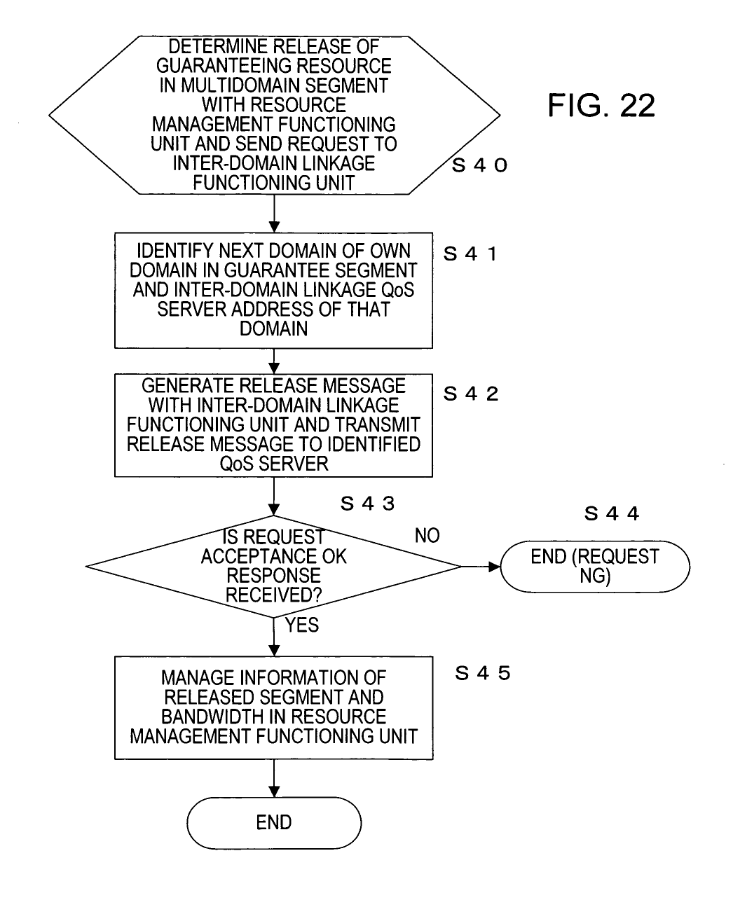

FIG. 22 isa resource release message generating process flow when it is determined by the determination flow of FIG. 21 that the release of the resource is requested.

First, the resource management functioning unit 31 of the inter-domain linkage QoS server 3A determines the release of the guaranteeing bandwidth with the determination flow shown in FIG. 21 and requests the inter-domain linkage functioning unit 33 to release the bandwidth (step S40).

The inter-domain linkage functioning unit 33 receives the release request and determines the next domain (domain B, in this embodiment) of the own domain in the guarantee segment and the address of the inter-domain linkage QoS server 3B in that domain (step S41).

Based on this identification, the inter-domain linkage functioning unit 33 generates a request message, which is transmitted to the identified inter-domain linkage QoS server 3B (step S42).

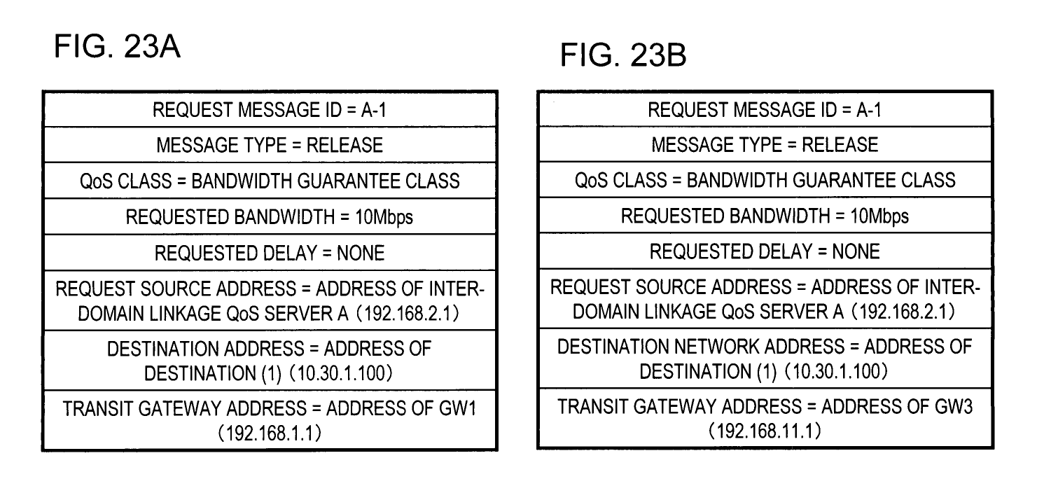

FIG. 23A shows an example of the format of the release request message generated in this situation. Although this format is similar to the guarantee bandwidth request message format (FIG. 11B), the message type is release and no direction is specified.

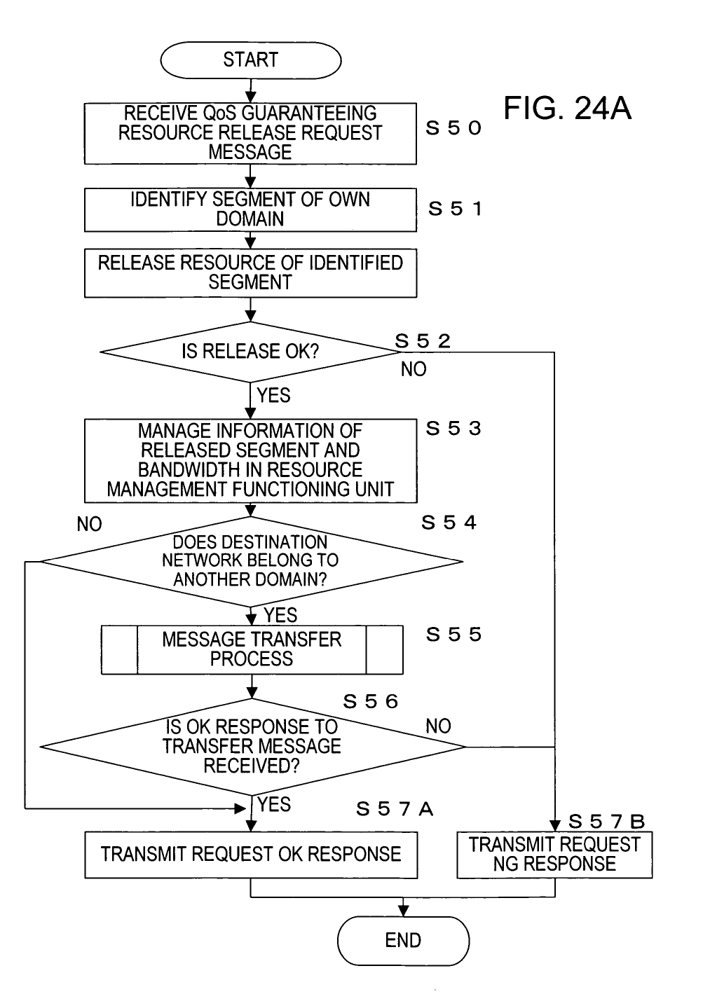

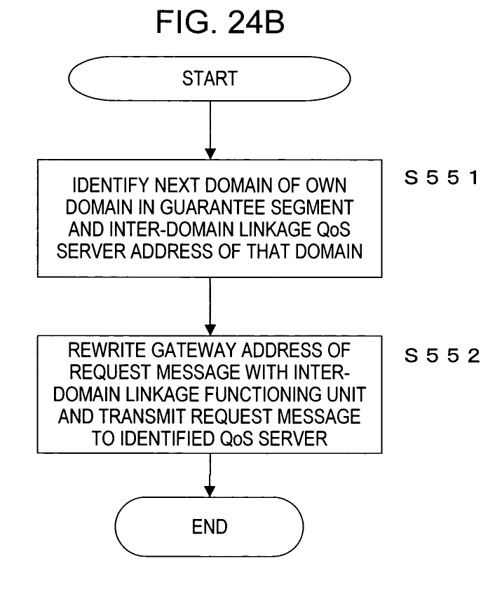

When receiving the release request from the inter-domain linkage QoS server 3A, the inter-domain linkage QoS server 3B performs processes shown in FIGS. 24A and 24B. That is, in FIG. 24A, the inter-domain linkage QoS server 3B receives the QoS guaranteeing resource release message from the inter-domain linkage QoS server 3A (step S50) and identifies the segment of the domain of the embodiment, i.e., the segment between the gateways GW2 and GW3 (step S51) . The release process is performed for the resource of the identified segment (step S51).

If the resource cannot be released, an NG response to the requested resource release request is returned (step S57B).

On the other hand, if the resource can be released (step S52, YES), the resource management functioning unit 31 updates and manages the information of the released segment and bandwidth (step S53).

It is determined whether the destination network of the release request message belongs to another domain or not, and if the destination is the own domain, i.e., the domain B, OK is transmitted for the request (step S57A).

On the other hand, if the destination network belongs to another domain (step S54, YES), the message is replaced with a transfer message, which is transferred to the relevant domain, i.e., the domain C in this embodiment. FIG. 24B shows details of the message transfer process of the inter-domain linkage QoS server 3B in this situation.

That is, the next domain of the own domain in the guarantee segment is identified and the address of the inter-domain linkage QoS server 3C in that domain is identified (step S551). The inter-domain linkage functioning unit 33 rewrites the gateway address (changed from GW1 to GW3) of the release request message in the release request transfer message format as shown in FIG. 23B and transfers the message to the identified inter-domain linkage QoS server 3C (step S552).

Referring to the flow of FIG. 24A again, the inter-domain linkage QoS server 3B determines whether the response to the transfer message from the inter-domain linkage QoS server 3C is OK or not (step S56).

If the response to the release request is OK (step S56, YES), the OK response to the request is transmitted to the inter-domain linkage QoS server 3A (step S57A) . If the response to the release request is NG (step S56, NO), the request NG response is transmitted to the inter-domain linkage QoS server 3A (step S57B).

As described in the embodiment, the present invention can quickly respond to a request from a customer and can achieve end-to-end quality guarantee communication while utilizing resources in accordance with a usage status in a large scale multidomain network. Therefore, the present invention can operate the network efficiently and makes a considerable contribution to the industry.

While the illustrative and presently preferred embodiments of the present invention have been described in detail herein, it is to be understood that the inventive concepts may be otherwise variously embodied and employed and that the appended claims are intended to be construed to include such variations except insofar as limited by the prior art.

What is claimed is:

1. A QoS guaranteeing method on a network path across a plurality of domains, the QoS guaranteeing method being performed by a QoS server included in a domain defined as a QoS guaranteeing resource request source, among QoS servers linking domains included in each of a plurality of domains, and comprising the steps of:
generating a QoS guaranteeing resource request message;
sending the generated QoS guaranteeing resource request message to a QoS server managing a next domain on the path; and
if resources can be reserved in all the domains on the path as a result of the QoS guaranteeing resource request of the QoS guaranteeing resource request message, managing resources for obtained QoS guarantee on the path from the next domain to a domain where a destination network address belongs.

2. The QoS guaranteeing method according to claim 1,
wherein the QoS server on the path across the plurality of domains performs the steps of:
receiving the QoS guaranteeing resource request on the path across the plurality of domains;
determining from destination network information included in the request whether the request is a request reaching to the next domain or not;
if it is determined that the request is a request reaching to the next domain, identifying the QoS server of the next domain;
identifying an own domain's gateway address connecting to the next domain; and
adding the gateway address to the request message and transferring the message to the QoS server of the next domain.

3. The QoS guaranteeing method according to claim 2,
wherein the QoS server on the path across the plurality of domains performs the steps of:
checking that a QoS guaranteeing resource satisfying the request can be allocated in the own domain; and
when a response to the transferred message indicates that the resource can be reserved, returning a notification indicating that the resource can be reserved to the transmission source QoS server of the QoS guaranteeing resource request located in a preceding domain.

4. The QoS guaranteeing method according to claim 1,
wherein the QoS server in the end domain of the path across the plurality of domains performs the steps of:
receiving the QoS guaranteeing resource request and determining that the own domain is an ending point since the destination network belongs to the own domain; and
if it is confirmed that the a QoS guaranteeing resource satisfying the request can be allocated in the own domain, returning a notification indicating that the resource can be reserved to the preceding domain's QoS server that has transferred the QoS guaranteeing resource request.

5. The QoS guaranteeing method according to claim 2,
wherein the QoS server in the end domain of the path across the plurality of domains performs the steps of:
receiving the QoS guaranteeing resource request and determining that the own domain is an ending point since the destination network belongs to the own domain; and
if it is confirmed that the a QoS guaranteeing resource satisfying the request can be allocated in the own domain, returning a notification indicating that the resource can be reserved to the preceding domain's QoS server that has transferred the QoS guaranteeing resource request.

6. The QoS guaranteeing method according to claim 3,
wherein the QoS server in the end domain of the path across the plurality of domains performs the steps of:
receiving the QoS guaranteeing resource request and determining that the own domain is an ending point since the destination network belongs to the own domain; and
if it is confirmed that the a QoS guaranteeing resource satisfying the request can be allocated in the own domain, returning a notification indicating that the resource can be reserved to the preceding domain's QoS server that has transferred the QoS guaranteeing resource request.

7. The QoS guaranteeing method according to claim 1,
wherein the QoS server on the path across the plurality of domains performs the steps of:
receiving the QoS guaranteeing resource request on the path across the plurality of domains;
identifying a segment in the own domain from the destination network and the preceding domain's gateway address included in the QoS guaranteeing resource request; and
allocating a necessary amount of the resource of the segment to the request source domain if the resource of the identified segment can be allocated for the request.

8. The QoS guaranteeing method according to claim 1,
wherein the QoS server included in the domain defined as the QoS guaranteeing resource request source performs the step of:
receiving from a customer a QoS guarantee request across the plurality of domains in the upward direction, i.e., the direction originated from the own domain;
determining from management resource information whether allocation can be achieved in a resource of an external domain identified by the destination address of the QoS guaranteeing resource request and in a resource of the own domain; and
returning a notification to the customer request to indicate that the resource can be reserved if the allocation can be achieved.

9. The QoS guaranteeing method according to claim 1,
wherein the QoS server included in the domain defined as the QoS guaranteeing resource request source performs the steps of:
receiving from a customer a QoS guarantee request across the plurality of domains in the downward direction, i.e., the direction ending at the own domain;
transferring the request message to the QoS server of the ending point domain identified by the destination address of the QoS guaranteeing resource request; and
returning a notification to the customer to indicate that the resource can be reserved if a response to the request message indicates that the resource can be reserved.

10. The QoS guaranteeing method according to claim 2,
wherein the QoS server on the path across the plurality of domains performs the steps of:
if the resource request message from a customer is transferred from the QoS server of another domain, determining from management resource information whether allocation can be achieved in a resource of an external domain identified by the request source address of the resource request message and in a resource of the own domain; and
returning a notification to the request source QoS server to indicate that the resource can be reserved if the allocation can be achieved.

11. The QoS guaranteeing method according to claim 1,
wherein the QoS server included in the domain defined as the QoS guaranteeing resource request source performs the steps of:
receiving from a customer a bidirectional QoS guarantee request across the plurality of domains;
transferring the QoS guarantee request message to the QoS server of the ending point domain identified by the destination address of the bidirectional QoS guarantee request;
determining from management resource information whether a response to the bidirectional QoS guarantee request message indicates that the resource can be reserved and whether allocation can be achieved in a resource of an external domain identified by the destination address of the bidirectional QoS guarantee request and in a resource of the own domain; and
returning a notification to the customer request to indicate that the resource can be reserved if the allocation can be achieved.

12. The QoS guaranteeing method according to claim 1,
wherein the QoS server included in the domain defined as the QoS guaranteeing resource request source performs the steps of:
if a managed other domain resource leading to destination network is greater than a threshold for a certain time period or more, generating a release request message for releasing a certain amount of the QoS guaranteeing resource;
transferring the release request message to the QoS server of the next domain identified from the destination network; and
updating the managed other domain resource if a response result of the release request message to the QoS server indicates that the resource can be reserved.

13. The QoS guaranteeing method according to claim 1, further comprising the steps of:
if the managed other domain resource leading to destination network is less than a threshold for a certain time period or more, generating a message for requesting a certain amount of the QoS guaranteeing resource;
transferring the generated message to the QoS server of the next domain identified from the destination network; and
updating the managed other domain resource if a response result of the message indicates that the resource can be reserved.

14. An inter-domain linkage QoS server disposed on a network path across a plurality of domains, comprising:
as an inter-domain linkage QoS server associated with the transmission source domain,
an inter-domain linkage functioning unit generating a QoS guaranteeing resource request message, and sending the generated QoS guaranteeing resource request message to the QoS server managing the next domain on the path; and
a resource management functioning unit managing the resources for obtained QoS guarantee on the path from the next domain to the domain where a destination network address belongs if resources can be reserved in all the domains on the path as a result of the QoS guaranteeing resource request of the QoS guaranteeing resource request message.

15. The inter-domain linkage QoS server according to claim 14, wherein the resource management functioning unit receives from a customer a QoS guarantee request across the plurality of domains in the upward direction, i.e., the direction originated from the own domain, determines from management resource information whether allocation can be achieved in a resource of an external domain identified by the destination address of the QoS guaranteeing resource request and in a resource of the own domain, and returnes a notification to the customer request to indicate that the resource can be reserved if the allocation can be achieved.

16. The inter-domain linkage QoS server according to claim 14, wherein the resource management functioning unit receives from a customer a QoS guarantee request across the plurality of domains in the downward direction, i.e., the direction ending at the own domain, transfers the request message to the QoS server of the ending point domain identified by the destination address of the QoS guaranteeing resource request; and returns a notification to the customer to indicate that the resource can be reserved if a response to the request message indicates that the resource can be reserved.

17. The inter-domain linkage QoS server according to claim 14, wherein the resource management functioning unit receives from a customer a bidirectional QoS guarantee request across the plurality of domains, transfers the QoS guarantee request message to the QoS server of the ending point domain identified by the destination address of the bidirectional QoS guarantee request; determines from management resource information whether a response to the bidirectional QoS guarantee request message indicates that the resource can be reserved and whether allocation can be achieved in a resource of an external domain identified by the destination address of the bidirectional QoS guarantee request and in a resource of the own domain; and returns a notification to the customer request to indicate that the resource can be reserved if the allocation can be achieved.

18. The inter-domain linkage QoS server according to claim 14, wherein the resource management functioning unit, if a managed other domain resource leading to destination network is greater than a threshold for a certain time period or more, generates a release request message for releasing a certain amount of the QoS guaranteeing resource; transfers the release request message to the QoS server of the next domain identified from the destination network; and updates the managed other domain resource if a response result of the release request message to the QoS server indicates that the resource can be reserved.

19. The inter-domain linkage QoS server according to claim 14, wherein the resource management functioning unit, if the managed other domain resource leading to destination network is less than a threshold for a certain time period or more, generating a message for requesting a certain amount of the QoS guaranteeing resource; transfers the generated message to the QoS server of the next domain identified from the destination network; and updates the managed other domain resource if a response result of the message indicates that the resource can be reserved.

20. A QoS guaranteeing method performed in an inter-domain linkage QoS server disposed on a network path across a plurality of domains, as a QoS server on the path across the plurality of domains, comprising the steps of:
receiving a QoS guaranteeing resource request from an inter-domain linkage QoS server associated with a transmission source domain, determining from destination network information included in the QoS guaranteeing resource request whether the request is a request reaching to the next domain or not, identifying the QoS server of the next domain if it is determined that the request is a request reaching to the next domain, identifying an own domain's gateway address connecting to the next domain; and
adding the gateway address to the request message to transfer the message to the QoS server of the next domain.

21. The QoS guaranteeing method according to claim 20, further comprising the steps of:
confirms that a QoS guaranteeing resource satisfying the request can be allocated in the own domain; and
when a response to the transferred message indicates that the resource can be reserved, returnning a notification indicating that the resource can be reserved to the transmission source QoS server of the QoS guaranteeing resource request located in a preceding domain.

22. The QoS guaranteeing method according to claim 20, further comprising the steps of:
if the resource request message from a customer is transferred from the QoS server of another domain, determining from management resource information whether allocation can be achieved in a resource of an external domain identified by the request source address of the resource request message and in a resource of the own domain; and
returning a notification to the request source QoS server to indicate that the resource can be reserved if the allocation can be achieved.

23. The QoS guaranteeing method according to claim 21, further comprising the steps of:
receiving the QoS guaranteeing resource request on the path across the plurality of domains;
identifying a segment in the own domain from the destination network and the preceding domain's gateway address included in the QoS guaranteeing resource request; and
allocating a necessary amount of the resource of the segment to the request source domain if the resource of the identified segment can be allocated for the request.

24. A QoS guaranteeing method performed in a QoS server of an end domain on a path across a plurality of domains, comprising the steps of:
receiving the QoS guaranteeing resource request from the inter-domain linkage QoS server associated with the transmission source domain;
determining that the own domain is an ending point since the destination network belongs to the own domain; and
if it is confirmed that the a QoS guaranteeing resource satisfying the request can be allocated in the own domain, returning a notification indicating that the resource can be reserved to the preceding domain's QoS server that has transferred the QoS guaranteeing resource request.
